(19) United States
(12) Patent Application Publication
(10) Pub. No.: US 2026/0292506 A1
(43) Pub. Date: Sep. 24, 2026

(54) RADIO RESOURCE CONTROL RESUME REQUEST MESSAGE PROTECTION

(71) Applicant: Apple Inc., Cupertino, CA (US)

(72) Inventors: Shu Guo, Beijing (CN); Dawei Zhang, Saratoga, CA (US); Fangli Xu, Beijing (CN); Haijing Hu, Los Gatos, CA (US); Huarui Liang, Beijing (CN); Yuqin Chen, Beijing (CN)

(21) Appl. No.: 19/480,065

(22) PCT Filed: May 11, 2023
(86) PCT No.: PCT/CN2023/093557

§ 371 Date: Oct. 30, 2025

(51) Int. Cl. H04W 12/106; H04W 74/0833; H04W 76/27

(52) U.S. Cl. CPC H04W 12/106; H04W 74/0833; H04W 76/27

(57) ABSTRACT

System, methods, and apparatus for protecting radio resource control (RRC) resume request message can include sending, by a target gNB (T-gNB), a system information (SI) message indicating a new message authentication code-integrity (MAC-I) capability for the T-gNB to a user equipment (UE), the UE in a radio resource control (RRC) inactive (RRC_Inactive) state; receiving, from the UE, an RRC resume request (RRCResumeRequest) message and an indication of a MAC-I version, the RRCResumeRequest message requesting connection to the T-gNB; sending, from the T-gNB to a source gNB (S-gNB), a Retrieve UE Context Request message indicating the MAC-I version; receiving, from the S-gNB, a Retrieve UE Context Response message; and sending, to the UE, a message based on the Retrieve UE Context Response message received from the S-gNB.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, a method for protecting radio resource control (RRC) resume request message can include sending, by a target gNB (T-gNB), a system information (SI) message indicating a new message authentication code—integrity (MAC-I) capability for the T-gNB to a user equipment (UE), the UE in a radio resource control (RRC) inactive (RRC_Inactive) state; receiving, from the UE, an RRC resume request (RRCResumeRequest) message and an indication of a MAC-I version, the RRCResumeRequest message requesting connection to the T-gNB; sending, from the T-gNB to a source gNB (S-gNB), a Retrieve UE Context Request message indicating the MAC-I version; receiving, from the S-gNB, a Retrieve UE Context Response message; and sending, to the UE, a message based on the Retrieve UE Context Response message received from the S-gNB.

In some embodiments, the indication of the MAC-I version is received in a physical random access channel (PRACH) resource reserved for indicating a MAC-I type.

Some embodiments include determining the MAC-I version from the PRACH resource received from the UE.

In some embodiments, the SI message comprises an indication of the new MAC-I in a PRACH resource reserved for the new MAC-I.

In some embodiments, the indication of the MAC-I version is received in a medium access control (MAC) control element (CE) for MAC-I type.

In some embodiments, the indication of the MAC-I version is received in the RRCResumeRequest message.

In some embodiments, receiving a Retrieve UE Context Response message includes receiving a verification of the UE capability based on S-gNb decoding the MAC-I version in the Retrieve UE Context Request message; and sending, to the UE, a message based on the Retrieve UE Context Response message received from the S-gNB includes sending an RRC Resume message to the UE.

In some embodiments, receiving, from the S-gNB, a Retrieve UE Context Response message includes receiving a Retrieve UE Context failure message; and sending, to the UE, an RRC reject message that includes the new MAC-I version.

In some embodiments, receiving, from the S-gNB, a Retrieve UE Context Response message includes receiving a Retrieve UE Context Failure message; and sending, to the UE, an RRC reject message that includes an indication of an incorrect MAC-I version.

In some embodiments, the Retrieve UE Context Failure message includes an indication for the reason for rejection as a wrong MAC-I type.

Aspects of the embodiments are directed to a non-transitory computer storage medium encoded with instructions that, when executed by one or more computers, cause the one or more computers to perform the method performed by the target gNB described above and in the claims.

Aspects of the embodiments are directed to a base station comprising one or more processors and one or more storage devices on which are stored instructions that are operable, when executed by the one or more processors, to cause the one or more processors to perform the method performed by the target gNB described above and in the claims.

Aspects of the embodiments are directed to a method performed by a user equipment (UE) for performing a radio resource control (RRC) connect procedure from an RRC inactive state, the method including receiving, from a source gNB (S-gNB), an RRC release with suspend configuration (RRCRelease withSuspendConfig) message, the RRCRelease withSuspendConfig comprising a message authentication code-integrity (MAC-I) capability for the S-gNB, the MAC-I capability comprising a first version of a MAC-I; entering into an RRC_Inactive state; receiving, from a target gNB (T-gNB) different from the S-gNB, a system information block (SIB), the SIB indicating a MAC-I capability for the T-gNB, the MAC-I capability of the T-gNB comprising a second version of a MAC-I, the second version older than the first version; generating a resume MAC-I from the second version of the MAC-I; generating an RRC resume request message using the resume MAC-I; and transmitting the RRC resume request message with the resume MAC-I to the T-gNB.

Some embodiments include transmitting an indication to the T-gNB of a version of the MAC-I.

In some embodiments, the indication of the version of the MAC-I is transmitted in a physical random access channel (PRACH) resource.

In some embodiments, the indication of the version of the MAC-I is transmitted in a medium access control (MAC) control element (CE) for MAC-I.

In some embodiments, the indication of the version of the MAC-I is transmitted in a field of the RRC resume request message.

Some embodiments include receiving, from the T-gNB, an RRC reject message that includes the first version of the MAC-I; generating a new resume MAC-I using the first MAC-I version; generating a new RRC resume request with the new resume MAC-I; and sending the new RRC resume request with the new resume MAC-I to the T-gNB.

Some embodiments include receiving, from the T-gNB, an RRC reject message that includes an indication of an incorrect MAC-I version; identifying a correct MAC-I version from a UE capability, the correct MAC-I comprising the first version of the MAC-I; generating a new resume MAC-I using the first version of the MAC-I; generating a new RRC resume request with the new resume MAC-I; and sending the new RRC resume request with the new resume MAC-I to the T-gNB.

Some embodiments include receiving, from the T-gNB, an RRC resume message; and entering into an RRC connected state with the T-gNB.

Aspects of the embodiments are directed to a non-transitory computer storage medium encoded with instructions that, when executed by one or more processors, cause the one or more processors to perform the method performed by the UE above and in the claims.

Aspects of the embodiments are directed to a user equipment (UE) comprising one or more processors and one or more storage devices on which are stored instructions that are operable, when executed by the one or more processors, to cause the one or more processors to perform the method performed by the UE above and in the claims.

Aspects of the embodiments are directed to a baseband processor of a user equipment (UE), the baseband processor including processing circuitry to receive, from a source gNB (S-gNB), an RRC release with suspend configuration (RRCRelease withSuspendConfig) message, the RRCRelease withSuspendConfig comprising a message authentication code—integrity (MAC-I) capability for the S-gNB, the MAC-I capability comprising a first version of a MAC-I; cause the UE to enter into an RRC_Inactive state; receive, originating from a target gNB (T-gNB) different from the S-gNB, a system information block (SIB), the SIB indicating a MAC-I capability for the T-gNB, the MAC-I capability of the T-gNB comprising a second version of a MAC-I, the second version older than the first version; generate a resume MAC-I from the second version of the MAC-I; generate an RRC resume request message using the resume MAC-I; and transmit the RRC resume request message with the resume MAC-I to the T-gNB.

Some embodiments include processing circuitry to transmit an indication to the T-gNB of a version of the MAC-I.

In some embodiments, the indication of the version of the MAC-I is transmitted in a physical random access channel (PRACH) resource.

In some embodiments, the indication of the version of the MAC-I is transmitted in a medium access control (MAC) control element (CE) for MAC-I.

In some embodiments, the indication of the version of the MAC-I is transmitted in a field of the RRC resume request message.

Some embodiments include processing circuitry to receive, from the T-gNB, an RRC reject message that includes the first version of the MAC-I; generate a new resume MAC-I using the first MAC-I version; generate a new RRC resume request with the new resume MAC-I; and send the new RRC resume request with the new resume MAC-I to the T-gNB.

Some embodiments include processing circuitry to receive, from the T-gNB, an RRC reject message that includes an indication of an incorrect MAC-I version; identify a correct MAC-I version from a UE capability, the correct MAC-I comprising the first version of the MAC-I; generate a new resume MAC-I using the first version of the MAC-I; generate a new RRC resume request with the new resume MAC-I; and send the new RRC resume request with the new resume MAC-I to the T-gNB.

Aspects of the embodiments include processing circuitry to receive, from the T-gNB, an RRC resume message; and enter into an RRC connected state with the T-gNB.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates a wireless network, according to some implementations.

FIG. 2 is a schematic diagram 200 of an example message exchange for transitioning a UE to the RRC Inactive state and handover from a source gNB/ng-eNB (S-gNB) to a target gNB/ng-eNB (T-gNB) in accordance with embodiments of the present disclosure.

FIG. 3 is a swim-lane diagram 300 illustrating an example message flow for a source gNB to perform legacy fallback for verifying UE capabilities in accordance with embodiments of the present disclosure.

FIG. 4A is a swim-lane diagram 400 illustrating an example message flow for using a physical random access channel (PRACH) resource for communicating MAC-I version in accordance with embodiments of the present disclosure.

FIG. 4B is a swim-lane diagram 450 illustrating an example message flow for using a physical random access channel (PRACH) resource for communicating MAC-I version during a SIB corruption event in accordance with embodiments of the present disclosure.

FIG. 5 is a swim-lane diagram 500 illustrating an example message flow for using a MAC-I type medium access control (MAC) control element (CE) to indicate MAC-I type in accordance with embodiments of the present disclosure.

FIG. 6 is a swim-lane diagram 600 illustrating an example message flow for using a field within the RRCResumeRequest message to indicate MAC-I type in accordance with embodiments of the present disclosure.

FIG. 7 is a swim-lane diagram 700 illustrating an example message flow for a target gNB to indicate MAC-I capabilities in a RRCReject message in accordance with embodiments of the present disclosure.

FIG. 8 is a swim-lane diagram 800 illustrating an example message flow for a target gNB to indicate an RRCReject reason in accordance with embodiments of the present disclosure.

FIG. 10 illustrates an example user equipment (UE), according to some implementations.

FIG. 11 illustrates an example access node, according to some implementations.

Like reference numbers indicate like components or features.

### DETAILED DESCRIPTION

New Radio (NR, often referred to as 5G) supports a radio resource control (RRC) inactive state (RRC_Inactive). A UE can be caused to enter the RRC_Inactive state by an RRCRelease withSuspendConfig message received from a gNB. UE can enter the RRC Inactive state due to various reasons. For example, if the UE is not actively using any network services, it may enter the RRC Inactive state to conserve battery power. The network can release the UE from its RRC connection due to several reasons such as resource constraints or network maintenance. If the UE is unable to maintain a stable connection with the network due to poor signal quality, it may enter the RRC_Inactive state. When a UE performs a handover to another cell or network, it may temporarily enter the RRC_Inactive state before establishing a new connection with the target cell or network. When the UE is in idle mode and it receives signals from another cell with better signal quality, it may initiate a cell reselection procedure and temporarily enter the RRC_Inactive state before establishing a connection with the target cell.

5G New Radio (NR) has an RRC (Radio Resource Control) Inactive state for several reasons, including the following: 1) Power Saving: When a UE (User Equipment) is not actively connected to the network, it can conserve battery power by entering the RRC_Inactive state. In this state, the UE does not need to monitor or transmit any signals, which reduces power consumption; 2) Network Resource Optimization: By releasing radio resources when they are not needed, the network can optimize its resource allocation and reduce interference. The RRC Inactive state enables the network to allocate resources to other UEs that need them, improving overall network performance; 3) UE Mobility: When a UE is moving through different network coverage areas, it may temporarily lose connection with the network. The RRC Inactive state allows the UE to release its radio resources and re-establish them when it returns to an area with network coverage; 4) Network Congestion Management: When there are many UEs connected to the network, the network may experience congestion. The RRC Inactive state allows the network to release resources from UEs that are not actively using them, which can help manage network congestion.

The RRC_Inactive state in 5G NR provides benefits for power saving, network resource optimization, UE mobility, and network congestion management. By releasing resources when they are not needed, both the UE and the network can operate more efficiently.

Once the UE enters the RRC_Inactive state, it does not actively transmit or receive any signals and conserves battery power. However, it can still perform some tasks such as cell reselection, measurement reporting, and tracking area update. To establish a connection with the network again, the UE needs to initiate an RRC resume request procedure (including the transmission of an RRCResumeRequest message with a MAC-I) and re-establish its radio resources with the network. The RRC resume request procedure allows the UE to quickly reestablish the RRC connection with the network, which facilitates low latency reconnection while also supporting the benefits of the RRC_Inactive state, as described above.

The RRCResumeRequest message should be protected from external attacks or other forms of corruption. UE/gNB/ng-eNB may support full RRCResumeRequest message protection features, which means that the UE supports the calculation of the ResumeMAC-I/shortResumeMAC-I using the whole RRCResumeRequest message.

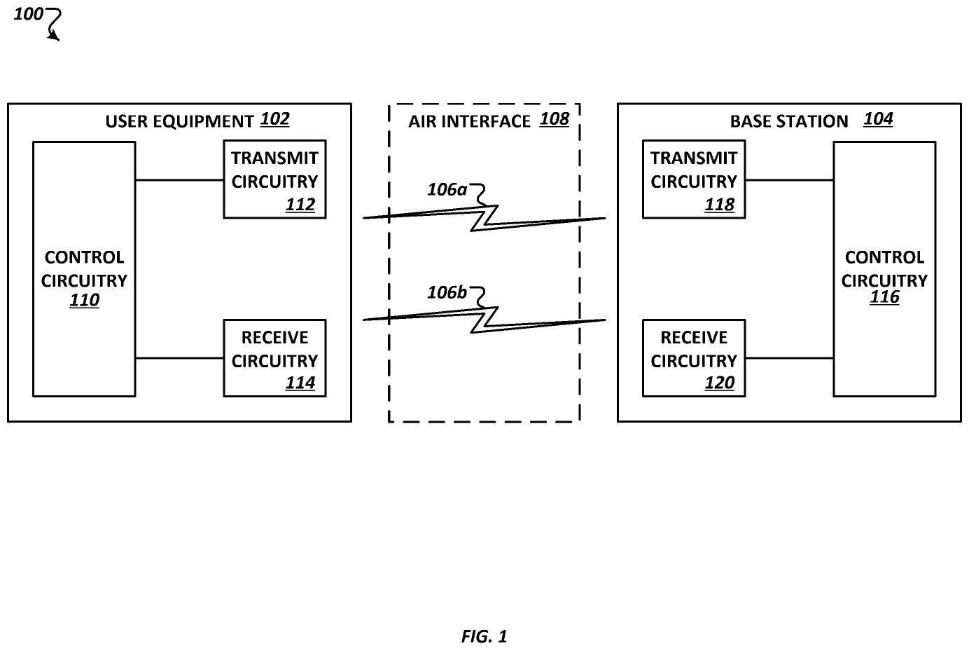

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can

The transmit circuitry 112 can perform various operations described in this specification. For example, the transmit circuitry 112 can. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

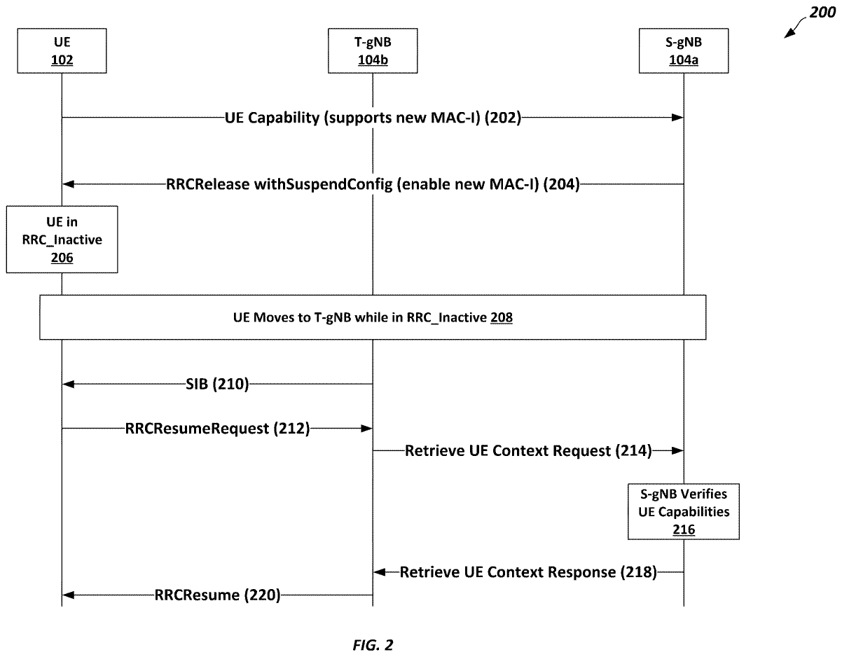

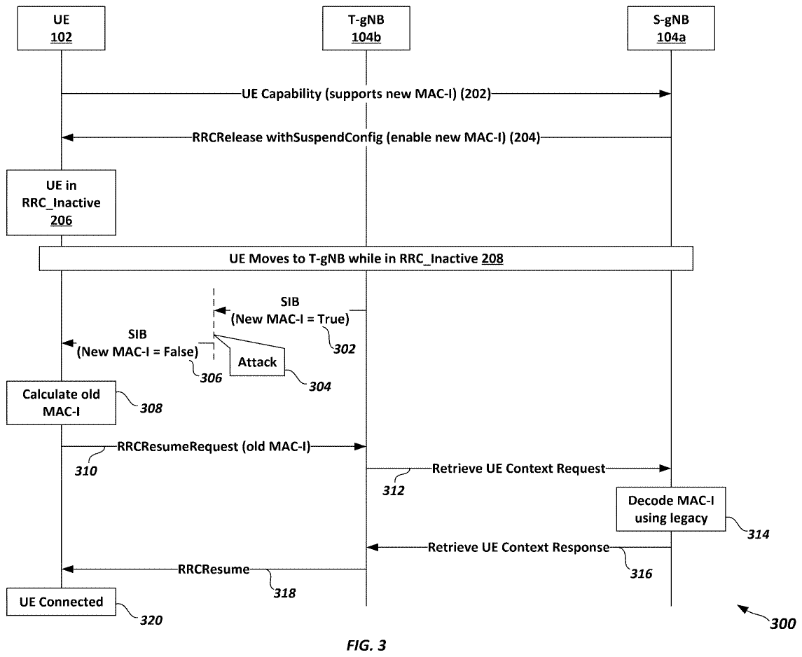

FIG. 2 is a schematic diagram 200 of an example message exchange for transitioning a UE 102 to the RRC_Inactive state and handover from a source gNB/ng-eNB (S-gNB) 104a to a target gNB/ng-eNB (T-gNB) 104b in accordance with embodiments of the present disclosure. At (202), the UE can exchange UE capability information with the gNB/ng-eNB, e.g., using an RRC message or other handshake protocol. In embodiments, step (202) can include an RRC connect message that connects the UE 102 with the S-gNB 104a. UE capability is an RRC signaling mechanism by which UE 102 can inform its capabilities to the S-gNB 104a. The S-gNB 104a can request the UE 102 to inform about the UE capability by sending a UE Capability Enquiry message, and UE 102 responds to this request by sending UE Capability Information message, which can be an RRC message. In embodiments, the UE 102 can inform the S-gNB of the UE capability for MAC-I version (e.g., a UE capability can include an indication of the MAC-I version the UE supports-here, the term new MAC-I refers to a latest version of MAC-I, such as that used in New Radio, and old MAC-I refers to older versions or legacy versions of MAC-I, such as those supported by LTE-A). The term old MAC-I can refer to a definition of MAC-I in TS 38.331, Clause 7.4, which specifies the VarResumeMac-I inputs for generating the ResumeMAC-I during RRC Connection Procedure: “VarResumeMAC-Input”: : =Seq{“source PCI, target Cell-ID, source C-RNTI.”}.

The new MAC-I input can include: {“source PCI, target Cell-ID, source C-RNTI, and all IEs from RRCResumeRequest message.”}.

MAC-I stands for message authentication code—integrity. MAC-I is a special field added by the packet data convergence protocol (PDCP) layer to each RRC message for the purpose of integrity protection. For example, at (204), the UE is to transition from RRC_Connected to RRC_Inactive. The S-gNB 104a can send the UE 102 an RRCRelease with SuspendConfig message. The RRCRelease with SuspendConfig message can include indications of the S-gNB 104a capabilities. The RRCRelease withSuspendConfig can include information about MAC-I for the UE to store and use when transitioning from RRC_Inactive to RRC Connected. In some cases, the UE supports a new MAC-I, and if so, the RRCRelease withSuspendConfig message will include the new MAC-I. In that RRCRelease withSuspendConfig message, the gNB/ng-eNB shall include a fresh Inactive-Radio Network Temporary Identifier (I-RNTI), an NCC, and an indication to use the ResumeMAC-I/shortResumeMAC-I calculated using the whole RRCResumeRequest message if the gNB/ng-eNB supports this method of calculating the ResumeMAC-I/shortResumeMAC-I. The UE 102 can store the MAC-I (and other information) as part of the UE context during RRC_Inactive state, which the UE can use when calculating RRCResumeRequest to return to the RRC_Connected state.

At (206), the UE 102 enters into the RRC_Inactive state.

The S-gNB 104a, which in this disclosure supports the calculation of the ResumeMAC-I/shortResumeMAC-I using the whole RRCResumeRequest message, shall broadcast an indication in its System Information (SI or SIB) that UEs connecting to it shall perform the calculation of the ResumeMAC-I/shortResumeMAC-I using the whole RRCResumeRequest message.

If the UE supports the calculation of ResumeMAC-I/shortResumeMAC-I using the whole RRCResumeRequest message, and the UE determines that both the S-gNB 104a and the T-gNB 104b support the calculation of the ResumeMAC-I/shortResumeMAC-I using the whole RRCResumeRequest message, the MESSAGE input shall be set with following inputs: source PCI, target Cell-ID, source C-RNTI, all IEs from RRCResumeRequest message.

The ResumeMAC-I/shortResumeMAC-I is a 16-bit message authentication token, the UE shall calculate it using the integrity algorithm (NIA or EIA) in the stored AS security context, which was negotiated between the UE and the S-gNB 104a.

In a handover scenario at (208), the S-gNB can determine that the UE 102 is no longer within the range of the S-gNB cell (e.g., via paging or other techniques). The S-gNB can request that neighboring gNBs provide information about whether the UE 102 has moved into the neighboring cell. In this case, the T-gNB 104b can determine that the UE has entered into its cell, and can send the UE a SIB, at (210), for capability exchange. UE 102 receives the SIB from the T-gNB 104b, which includes the T-gNB 104b capability.

When the UE 102, S-gNB 104a, and T-gNB 104b all support 1) new MAC-I and 2) the calculation of ResumeMAC-I/shortResumeMAC-I using the whole RRCResumeRequest message, the UE 102, at (212), can send the new ResumeMAC-I to the T-gNB 104b with a RRCResumeRequest message when it wants to transition to RRC_Connected. The T-gNB 104b, at 214), will send the ResumeMAC-I and the whole RRCResumeRequest message to the S-gNB 104a for the verification. This can be done with the Retrieve UE Context Request message, for example.

When a T-gNB 104b receives the RRCResumeRequest message from the UE 102, the T-gNB 104b extracts the I-RNTI from the RRCResumeRequest message. The T-gNB 104b contacts the S-gNB 104a based on the information in the I-RNTI by sending an Xn-AP Retrieve UE Context Request message with the following included: I-RNTI, the ResumeMAC-I/shortResumeMAC-I and target Cell-ID, in order to allow the S-gNB 104ato validate the UE request and to retrieve the UE context including the UE 5G AS security context. The S-gNB 104a retrieves the stored UE context including the UE 5G AS security context from its database using the I-RNTI and verifies the ResumeMAC-I/shortResumeMAC-I.

If the ResumeMAC-I/shortResumeMAC-I is decoded successfully, then the S-gNB 104a knows the capability of the UE 102 and the T-gNB 104b, and can verify the UE context and capabilities to the T-gNB 104b (216). The S-gNB 104a, at (218) will notify the T-gNB 104b (e.g., using a Retrieve UE Context response message). The T-gNB 104b, at (220), will accept the ResumeRequest from UE 102.

If the T-gNB 104b rejects the RRC Resume Request by sending RRCReject message, then the gNB shall include the received resumeCause in the RRC Reject message. If the UE 102 receives RRCReject message from the T-gNB 104b in response to the UE's RRC Resume Request message, then the UE 102 shall verify whether the resumeCause sent in the RRC Resume Request message is same as the resumeCause received in the RRCReject message.

If the T-gNB 104b capability in the SIB message is modified, then the procedure would include:

UE 102 sends its capability to the S-gNB 104a and at some point, the S-gNB 104a indicates its capability to the UE 102 in the RRCRelease message in the SuspendConfig. (which is a secure message), as described above in FIG. 2.

If there is an attacker between UE 102 and T-gNB 104b, UE 102 could receive a modified SIB from the T-gNB 104b. In these scenarios, the T-gNB 104b supports the new features, however after modification, the capability included in the SIB indicates that the T-gNB does NOT support the new feature. In that scenario:

UE 102 will send an old ResumeMAC-I in the ResumeRequest message to the T-gNB 104b. The T-gNB 104b will in turn send the old ResumeMAC-I and the corresponding parameters to the S-gNB 104a for verification. The S-gNB 104a, knowing the capability of the UE 102 and the T-gNB 104b, will expect the new ResumeMAC-I from the T-gNB 104b. However, because the T-gNB 104b sent the old Resume MAC-I to the S-gNB 104b, the S-gNB 104a will determine this as an error and will reject this MAC_I verification.

Accordingly, the SIB message sent from T-gNB 104b to the UE 102 for handover is not protected, and there is possibility that the T-gNB's capability for supporting the new features is modified by an attacker. This disclosure describes techniques to handle the handover in the case where the SIB is unprotected.

The following portions of the disclosure describe methods to address the above mentioned failure case:
Option #1: S-gNB 104a accepts the old ResumeMAC-I even when the S-gNB 104a is expecting a new ResumeMAC-I when S-gNB 104a knows that each of the UE 102, S-gNB 104a, and T-gNB 104b support the feature.
Option #2: UE 102 indicates to the T-gNB 104b whether the MAC-I in RRCResume is updated or not, and T-gNB 104b can forward the information to S-gNB 104a together with RRCResumeRequest message; and S-gNB 104a can perform the old or new MAC-I verification based on the indication.
Option #2.1: Introduce the special PRACH partition (PRACH resource+preamble set), which is used for the Msg3 transmission with the enhanced MAC-I. And based on the PRACH resource, the gNB can decide which is used for the Msg1 transmission to identify the MAC-I type in Msg3 RRCResumeRequest message.
Option #2.2:
Option 2.2.1: Introduce a new MAC-I type MAC CE which is to indicate the MAC-I type and transmitted together with RRCResumeRequest in the same Msg3 message.
Option 2.2.2: Update the RRCResumeRequest message, and add a new field in side to indicate the MAC-I type.
Option #3: The T-gNB 104b could indicate to the UE its capability in the Reject message, so that UE could compare this one with the previous one received in the SIB messages.
Option #4: if the T-gNB 104b could detect the existence of the attacker (e.g. with the help of option #2), the T-gNB 104b indicates in the RRCReject reason as “wrong version of Resume MAC-I.”
Option #5: When S-gNB 104a and T-gNB 104b are the same one, i.e UE send RRCResumeRequest message to S-gNB 104a again, UE will rely on the gNB (the S-gNB 104a) capability information carried in RRCRelease message with SuspendConfig when determining the ResumeMAC-I version.

In FIGS. 3-8 below, the UE has moved into the T-gNB cell.

FIG. 3 is a swim-lane diagram 300 illustrating an example message flow for a source gNB to perform legacy fallback for verifying UE capabilities in accordance with embodiments of the present disclosure. (Option #1) At the outset, the T-gNB 104b sends the UE a SIB message indicating that the T-gNB 104b supports a new MAC-I. (302) For example, SIB includes New MAC-I=True. At (304), an attack on the SIB message can occurs, such as by a MitM attacker. The attack can include a corruption of the new MAC-I indication, where the SIB message includes New MAC-I=False. (306). The UE can calculate an old MAC-I for the T-gNB 104b. (308) The UE can then send an RRCResumeRequest using the old MAC-I to the T-gNB 104b. (310). The T-gNB 104b sends a retrieve UE context request message to the S-gNB with the old ResumeMAC-I. (312)

The S-gNB 104a accepts the old Resume MAC-I even when the S-gNB 104a is expecting a new MAC-I (since the S-gNB knows that the UE 102, S-gNB 104a, and T-gNB 104b support this feature. (314) In this case the S-gNB 104a decodes the MAC-I using legacy MAC-I and can verify the UE context (which will not be removed), and therefore UE 102 will not be rejected by the T-gNB 104b. Whether S-gNB 104a allows the UE 102 with old MAC-I to be accessed could be up to the policy or network implementation. The S-gNB 104a fallbacks to decode MAC-I in legacy way if the new MAC-I decode fails. MAC-I is verified successfully via legacy way. If policy allow the UE 102 access with old MAC-I, S-gNB 104a can approve the access.

The S-gNB 104a can then send the Retrieve UE Context response message to the T-gNB. (316). The T-gNB 104b can send an RRCResume message to the UE 102. (318). The UE can then be connected (RRC_Connected) to the T-gNB 104b. (320)

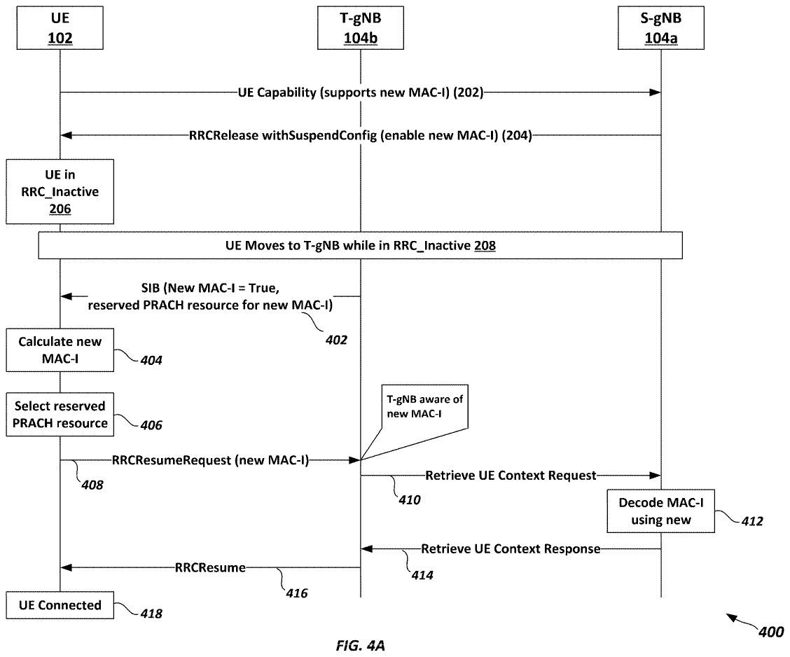

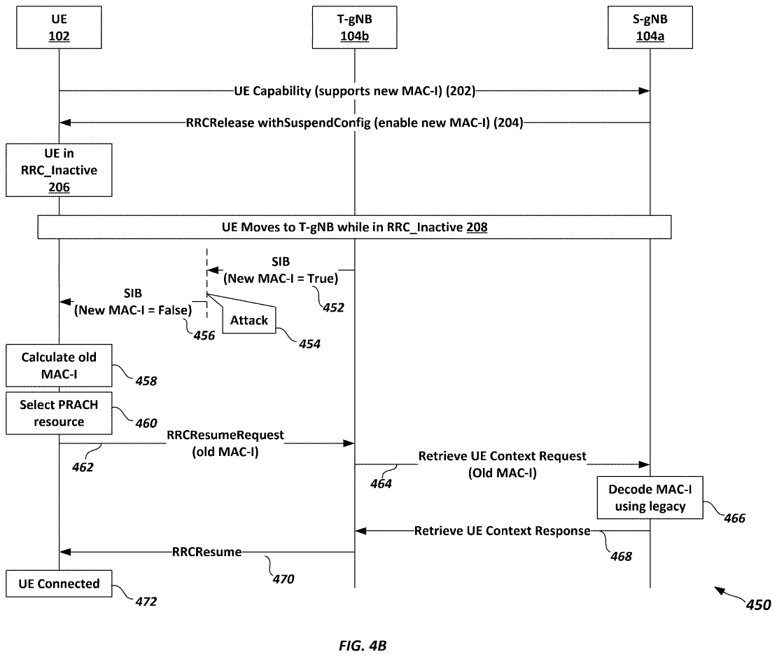

FIG. 4A is a swim-lane diagram 400 illustrating an example message flow for using a physical random access channel (PRACH) resource for communicating MAC-I version in accordance with embodiments of the present disclosure. (Option #2.1) FIG. 4A introduces a special PRACH partition (PRACH resource+preamble set) that is used for the Msg3 transmission with the enhanced MAC-I. And based on the PRACH resource gNB can decide which is used for the Msg1 transmission to identify the MAC-I type in Msg3 RRCResumeRequest message.

The T-gNB 104b sends the UE 102 a SIB that indicates the new MAC-I capability. (402) The SIB also includes an indication of the PRACH resource for the new MAC-I indication. The UE 102 calculates the new MAC-I for the RRCResume. (404) The UE selects the reserved PRACH resource for the new MAC-I. (406) The UE 102 sends the RRCResumeRequest with the new MAC-I using the special PRACH resource for the PRACH to the T-gNB 104b. (408) The T-gNB 104b is aware of the new MAC-I from the PRACH partition indication.

The T-gNB 104b sends the retrieve UE context request to the S-gNB. (410) The S-gNB decodes the new MAC-I for the UE capability verification. (412) The S-gNB 104a can then send the Retrieve UE Context response message to the T-gNB. (414). The T-gNB 104b can send an RRCResume message to the UE 102. (416). The UE can then be connected (RRC_Connected) to the T-gNB 104b. (418)

FIG. 4B is a swim-lane diagram 450 illustrating an example message flow for using a physical random access channel (PRACH) resource for communicating MAC-I version during a SIB corruption event in accordance with embodiments of the present disclosure. At the outset, the T-gNB 104b sends the UE a SIB message indicating that the T-gNB 104b supports a new MAC-I. (452) For example, SIB includes New MAC-I=True. At (454), an attack on the SIB message can occurs, such as by a MitM attacker. The attack can include a corruption of the new MAC-I indication, where the SIB message includes New MAC-I=False. (456).

The UE 102 can calculate the old MAC-I. (458) The UE selects the PRACH resource for the old MAC-I. (460) The UE sends the RRCResumeRequest using the old MAC-I and the PRACH partition for the old MAC-I. (462) The T-gNB 104b is aware that the RRCResumeRequest uses the old MAC-I based on the PRACH resource UE 102 is using. The T-gNB 104b sends the Retrieve UE Context Request using the old MAC-I to the S-gNB 104a. The S-gNB decodes the old MAC-I using legacy techniques.

The S-gNB 104a can then send the Retrieve UE Context response message to the T-gNB. (316). The T-gNB 104b can send an RRCResume message to the UE 102. (318). The UE can then be connected (RRC_Connected) to the T-gNB 104b. (320)

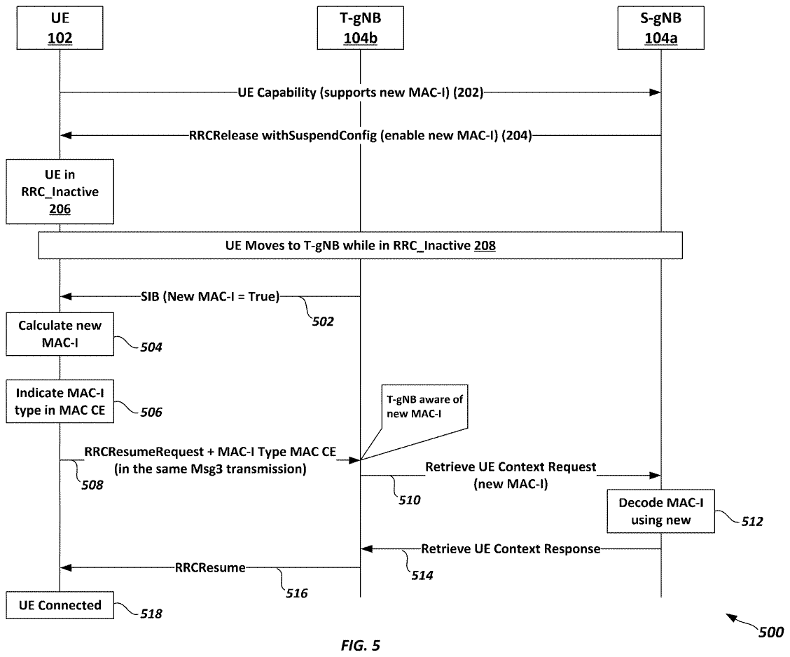

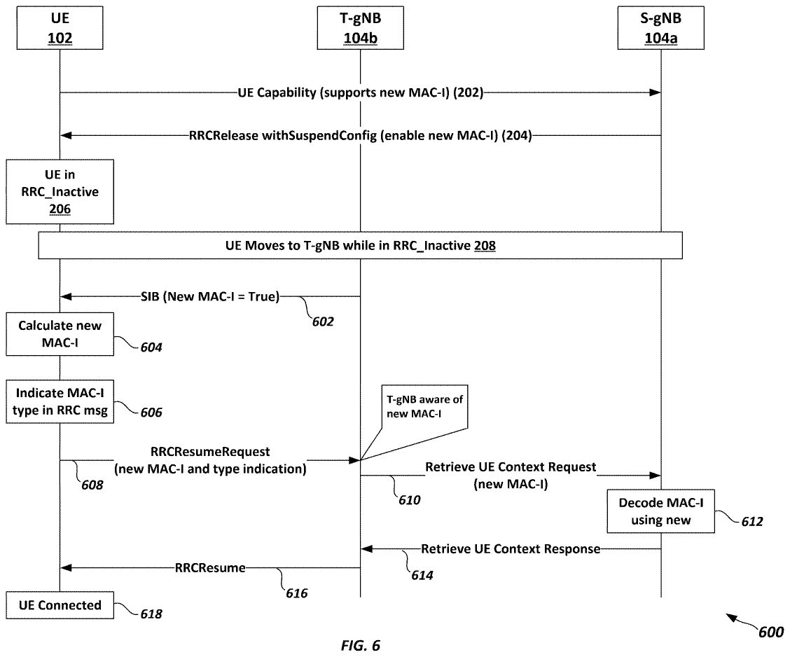

FIG. 5 is a swim-lane diagram 500 illustrating an example message flow for using a MAC-I type medium access control (MAC) control element (CE) to indicate MAC-I type in accordance with embodiments of the present disclosure. (Option #2.2) In FIG. 5, a new MAC-I type MAC CE is introduced, which is to indicate the MAC-I type and transmitted together with RRCResumeRequest in the same Msg3 message. The T-gNB 104b sends the UE 102 a SIB that indicates the new MAC-I capability. (502) The UE 102 calculates the new MAC-I for the RRCResume. (504) The UE indicates the MAC-I type in a MAC CE. (506) The UE 102 sends the RRCResumeRequest with the new MAC-I type MAC CE to the T-gNB 104b in the same Msg3 transmission. (508) The T-gNB 104b is aware of the new MAC-I from the MAC CE indication, if new MAC-I type is indicated.

The T-gNB 104b sends the retrieve UE context request to the S-gNB. (510) The S-gNB decodes the new MAC-I for the UE capability verification. (512) The S-gNB 104a can then send the Retrieve UE Context response message to the T-gNB. (514). The T-gNB 104b can send an RRCResume message to the UE 102. (516). The UE can then be connected (RRC_Connected) to the T-gNB 104b. (518)

FIG. 6 is a swim-lane diagram 600 illustrating an example message flow for using a field within the RRCResumeRequest message to indicate MAC-I type in accordance with embodiments of the present disclosure. (Option #2.2.2) In FIG. 6, the UE can update the RRCResumeRequest message, and add a new field in the RRCResumeRequest message to indicate the MAC-I type. The T-gNB 104b can send a SIB to the UE 102 indicating the new MAC-I=True. (602) The UE 102 can calculate the new MAC-I. (604) The UE 102 can includes the new MAC-I indication in a field of the RRCResumeRequest message. (606) The UE 102 can send the RRCResumeRequest message (with the new MAC-I and type indicated within) to the T-gNB 104b. (608) The T-gNB 104b becomes aware of the enw MAC-I capability from the RRCRequestRequest message.

The T-gNB 104b sends the retrieve UE context request to the S-gNB. (610) The S-gNB decodes the new MAC-I for the UE capability verification. (612) The S-gNB 104a can then send the Retrieve UE Context response message to the T-gNB. (614). The T-gNB 104b can send an RRCResume message to the UE 102. (616). The UE can then be connected (RRC_Connected) to the T-gNB 104b. (618)

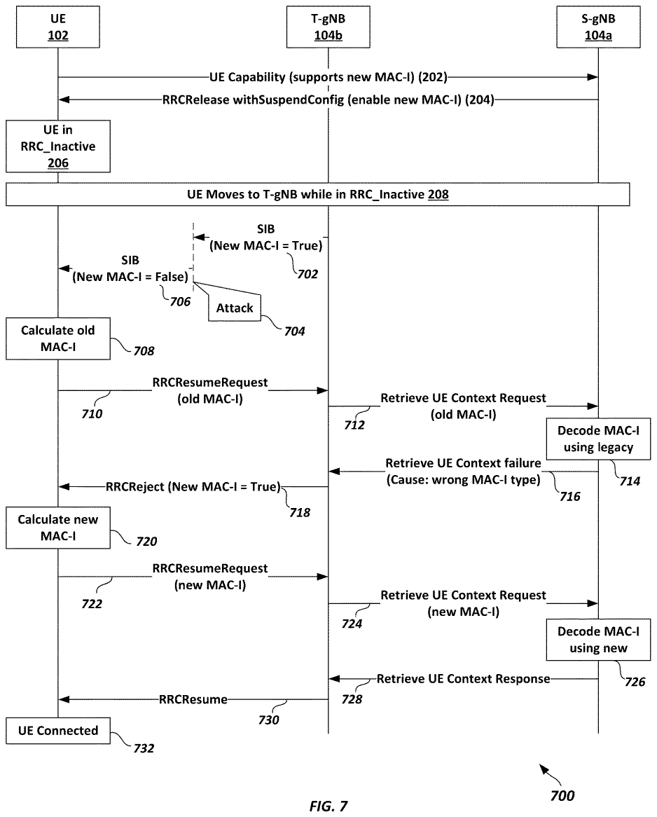

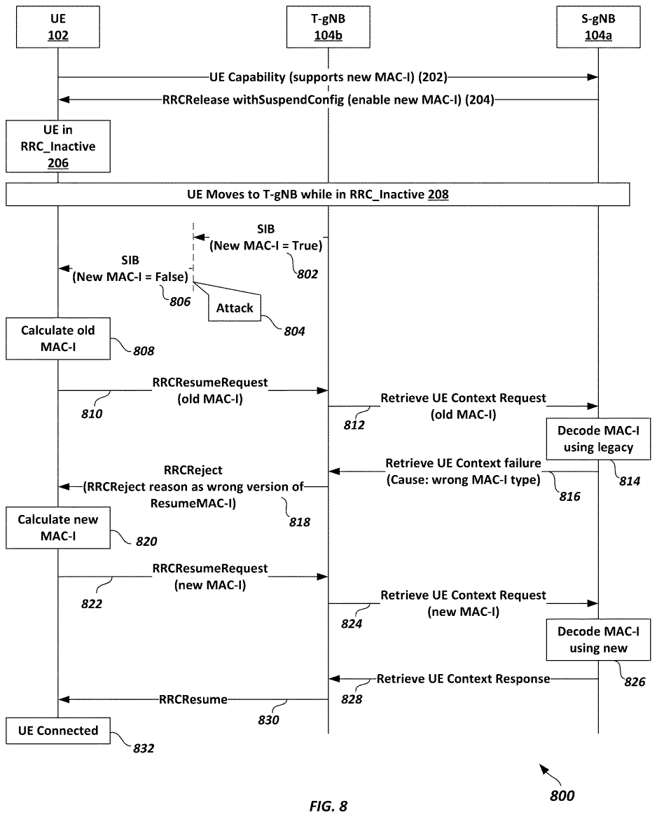

FIG. 7 is a swim-lane diagram 700 illustrating an example message flow for a target gNB to indicate MAC-I capabilities in a RRCReject message in accordance with embodiments of the present disclosure. (Option #3) The T-gNB 104b could indicate to the UE its capability in the Reject message, so that UE could compare this one with the previous one received in the SIB messages.

At the outset, the T-gNB 104b sends the UE a SIB message indicating that the T-gNB 104b supports a new MAC-I. (702) For example, SIB includes New MAC-I=True. At (704), an attack on the SIB message can occurs, such as by a MitM attacker. The attack can include a corruption of the new MAC-I indication, where the SIB message includes New MAC-I=False. (706).

The UE 102 can calculate the old MAC-I. (708) The UE 102 can send an RRC ResumeRequest message with the old MAC-I to the T-gNB 104b. (710) The T-gNB 104b can send a Retrieve UE Context request to the S-gNB 104a. (712) The S-gNB 104a can decode the MAC-I using legacy techniques. (714) The S-gNB 104a can fallback to decode MAC-I in legacy way if the new MAC-I decode fails. MAC-I is verified successfully via legacy techniques. If the policy does not allow the UE access with the old MAC-I, the S-gNB 104a cannot approve the access. Therefore, the S-gNB 104a can send a Retrieve UE context failure message to the T-gNB 104b for the UE 102. (716) The failure message can include a cause, which is wrong MAC-I type. The T-gNB can determine that the failure was caused by the wrong MAC-I type and can resend the new MAC-I capability to the UE in the RRCReject message (new MAC-I Type=True in RRCReject). (718).

The UE 102 can calculate the new MAC-I. (720) The UE 102 can then send an RRCResumeRequest message with the new MAC-I to the T-gNB 104b. (722) The T-gNB 104b can send the Retrieve UE Context Request message to the S-gNB 104a with the new MAC-I. (724) The S-gNB can decode the new MAC-I to verify the UE capability. (726) The S-gNB 104a can send the Retrieve UE Context Response message to the T-gNB 104b verifying the UE 102. (728) The T-gNB 104b can send an RRCResume message to the UE 102. (730). The UE 102 can then be connected (RRC_Connected state) to the T-gNB 104b.

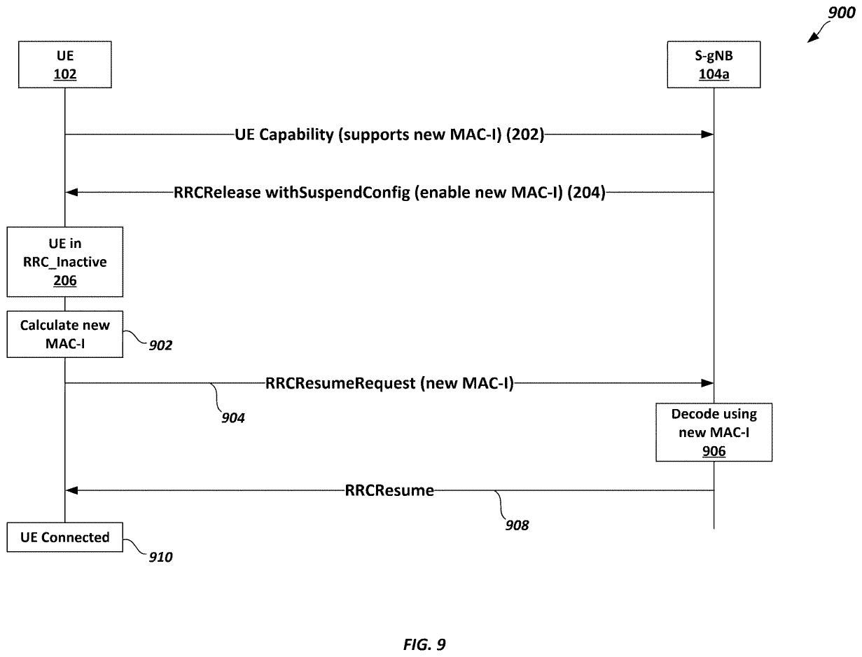

FIG. 8 is a swim-lane diagram 800 illustrating an example message flow for a target gNB to indicate an RRCReject reason in accordance with embodiments of the present disclosure. (Option #4) If the T-gNB 104b can detect the existence of the attack or the attacker (e.g. with the help of option #2), or the nature of the attack, the T-gNB 104b indicates in the RRCReject reason as “wrong version of Resume MAC-I.”

At the outset, the T-gNB 104b sends the UE a SIB message indicating that the T-gNB 104b supports a new MAC-I. (802) For example, SIB includes New MAC-I =True. At (804), an attack on the SIB message can occurs, such as by a MitM attacker. The attack can include a corruption of the new MAC-I indication, where the SIB message includes New MAC-I=False. (806).

The UE 102 can calculate the old MAC-I. (808) The UE 102 can send the RRCResumeRequest message to the T-gNB 104b with the old MAC-I. (810) The T-gNB 104b can send a Retrieve UE Context request to the S-gNB 104a. (812) The S-gNB 104a can decode the MAC-I using legacy techniques. (814) The S-gNB 104a can fallback to decode MAC-I in legacy way if the new MAC-I decode fails. MAC-I is verified successfully via legacy techniques. If the policy does not allow the UE access with the old MAC-I, the S-gNB 104a can approve the access.

The S-gNB 104a can send a Retrieve UE context failure message to the T-gNB 104b. (816) The failure message can include a cause, which is wrong MAC-I type. The T-gNB can determine that the failure was caused by the wrong MAC-I type and can send an RRCReject message with the reason as “wrong version of ResumeMAC-I” indicated. (818)

The UE 102 can calculate the new MAC-I (because the UE knows the UE capability and now will know that the old MAC-I is wrong). (820) The UE 102 can then send an RRCResumeRequest message with the new MAC-I to the T-gNB 104b. (822) The T-gNB 104b can send the Retrieve UE Context Request message to the S-gNB 104a. (824) The S-gNB can decode the new MAC-I to verify the UE capability. (826) The S-gNB 104a can send the Retrieve UE Context Response message to the T-gNB 104b verifying the UE 102. (828) The T-gNB 104b can send an RRCResume message to the UE 102. (830). The UE 102 can then be connected (RRC_Connected state) to the T-gNB 104b.

FIG. 9 is a swim-lane diagram 900 illustrating an example message flow for a UE to rely on source gNB capabilities indicated in the RRCRelease withSuspendConfig message in accordance with embodiments of the present disclosure. (Option 5) In FIG. 9, the UE 102, having been informed of the S-gNB 104a MAC-I capability from the RRCRelease with SuspendConfig message, calculates the new MAC-I. (902) The UE sends an RRCResumeRequest message with the new MAC-I to the S-gNB 104a. (904) The S-gNB 104a can decode using the new MAC-I to verify UE capabilities. (906) The S-gNB 104a can send the UE an RRCResume message. (908) The UE can then enter RRC Connected state (RRC_Connected) with the S-gNB 104a.

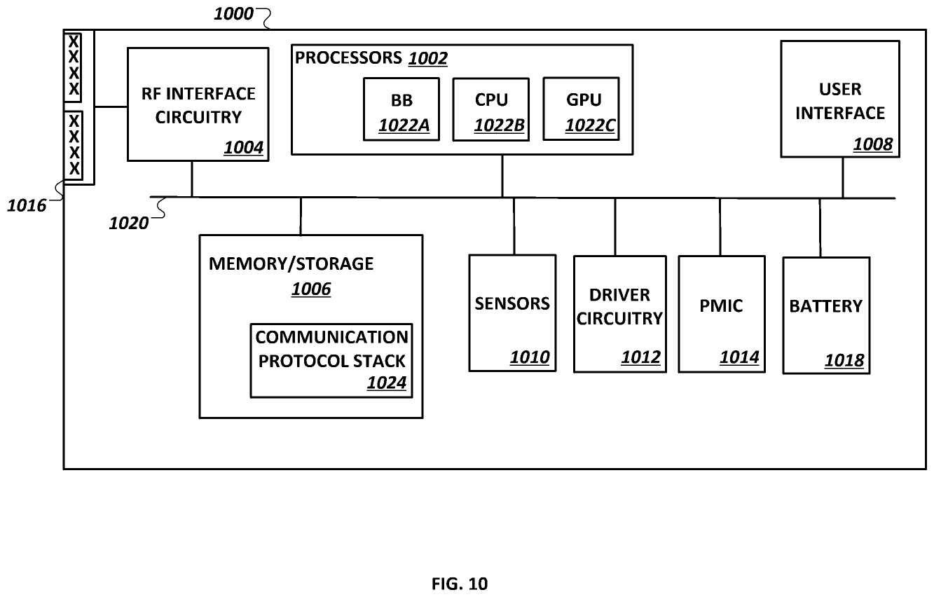

FIG. 10 illustrates an example UE 1000, according to some implementations. The UE 1000 may be similar to and substantially interchangeable with UE 102 of FIG. 1.

The UE 1000 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, one or more antenna(s) 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1016. In various implementations, the RF interface circuitry 1004 may be configured to transmit/receive signals in a manner compatible with NR access technologies.

The antenna(s) 1016 may include one or more antenna elements to convert electrical signals into radio waves to travel through the air and to convert received radio waves into electrical signals. The antenna elements may be arranged into one or more antenna panels. The antenna(s) 1016 may have antenna panels that are omnidirectional, directional, or a combination thereof to enable beamforming and multiple input, multiple output communications. The antenna(s) 1016 may include microstrip antennas, printed antennas fabricated on the surface of one or more printed circuit boards, patch antennas, phased array antennas, etc. The antenna(s) 1016 may have one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensors 1010 and control and allow access to sensors 1010, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

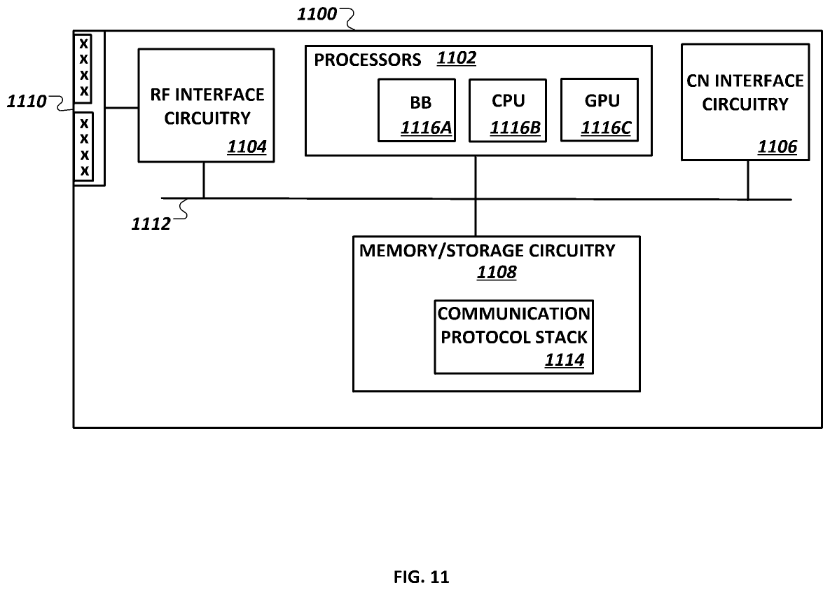

FIG. 11 illustrates an example access node 1100 (e.g., a base station or gNB), according to some implementations. The access node 1100 may be similar to and substantially interchangeable with base station 104. The access node 1100 may include processors 1102, RF interface circuitry 1104, core network (CN) interface circuitry 1106, memory/storage circuitry 1108, and one or more antenna(s) 1110.

The components of the access node 1100 may be coupled with various other components over one or more interconnects 1112. The processors 1102, RF interface circuitry 1104, memory/storage circuitry 1108 (including communication protocol stack 1114), antenna(s) 1110, and interconnects 1112 may be similar to like-named elements shown and described with respect to FIG. 10. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various implementations, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In V2X scenarios, the access node 1100 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-XXA.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-30. (canceled)

31. A target access node comprising one or more processors configured to, when executing instructions stored in a memory, perform operations comprising:
outputting a system information message for transmission to a user equipment (UE) in a radio resource control (RRC) inactive state, the system information message indicating a message authentication code—integrity (MAC-I) capability of the target access node;
receiving an RRC resume request message and an indication of a MAC-I version from the UE, the RRC resume request message requesting a connection to the target access node;
outputting a retrieve UE context request message to a source access node, the retrieve UE context request message indicating the MAC-I version provided by the UE;
receiving a retrieve UE context response message from the source access node; and
outputting a message for transmission to the UE based on the retrieve UE context response message received from the source access node.

32. The target access node of claim 31, wherein the indication of the MAC-I version is received using a physical random access channel (PRACH) resource reserved for indicating a MAC-I type.

33. The target access node of claim 32, further comprising determining the MAC-I version based on the PRACH resource used by the UE.

34. The target access node of claim 31, wherein the system information message is transmitted using a PRACH resource reserved for MAC-I capability signaling.

35. The target access node of claim 31, wherein the indication of the MAC-I version is received in a medium access control (MAC) control element (MAC-CE) for MAC-I type.

36. The target access node of claim 31, wherein the indication of the MAC-I version is received in the RRC resume request message.

37. The target access node of claim 31, wherein:
receiving the retrieve UE context response message comprises receiving a verification of a UE capability after the source access node decodes the MAC-I version in the retrieve UE context request message; and
outputting the message based on the retrieve UE context response message comprises outputting an RRC resume message for transmission to the UE.

38. The target access node of claim 31, wherein:
receiving the retrieve UE context response message comprises receiving a retrieve UE context failure message; and
the operations further comprise outputting an RRC reject message for transmission to the UE, the RRC reject message indicating a MAC-I version.

39. The target access node of claim 31, wherein:
receiving the retrieve UE context response message comprises receiving a retrieve UE context failure message; and
the operations further comprise outputting an RRC reject message for transmission to the UE, the RRC reject message indicating an incorrect MAC-I version.

40. The target access node of claim 39, wherein the retrieve UE context failure message indicates a reason for rejection, the reason comprising a wrong MAC-I type.

41. One or more processors configured to, when executing instructions stored in a memory, perform operations comprising:
receiving an RRC release message with a suspend configuration information element (IE), the RRC release message indicating a MAC-I capability of a source access node, the MAC-I capability comprising a first MAC-I version;
entering an RRC inactive state;
receiving a system information block (SIB) from a target access node, the SIB indicating a MAC-I capability of the target access node, the MAC-I capability of the target access node comprising a second MAC-I version; and
outputting an RRC resume request message for transmission to the target access node, the RRC resume request message comprising a resume MAC-I associated with the second MAC-I version.

42. The one or more processors of claim 41, the operations further comprising outputting an indication of a MAC-I version for transmission to the target access node.

43. The one or more processors of claim 42, wherein the indication of the MAC-I version is transmitted using a PRACH resource.

44. The one or more processors of claim 42, wherein the indication of the MAC-I version is transmitted using a MAC-CE configured for MAC-I capability signaling.

45. The one or more processors of claim 42, wherein the indication of the MAC-I version is transmitted in a field of the RRC resume request message.

46. The one or more processors of claim 41, the operations further comprising:
receiving an RRC reject message from the target access node, the RRC reject message indicating the first MAC-I version; and
outputting a RRC resume request message for transmission to the target access node, the RRC resume request message comprising a resume MAC-I associated with the first MAC-I version.

47. The one or more processors of claim 41, the operations further comprising:
receiving an RRC reject message from the target access node, the RRC reject message indicating an incorrect MAC-I version;
identifying a correct MAC-I version based on a UE capability, the correct MAC-I comprising the first MAC-I version; and
outputting an RRC resume request message for transmission to the target access node, the RRC resume request message comprising a resume MAC-I associated with the first MAC-I version.

48. The one or more processors of claim 41, the operations further comprising:
receiving an RRC resume message from the target access node; and
entering an RRC connected state.

49. A method comprising:
transmitting a system information message to a UE in an RRC inactive state, the system information message indicating a MAC-I capability of a target access node;
receiving an RRC resume request message and an indication of a MAC-I version from the UE, the RRC resume request message requesting a connection to the target access node;
sending a retrieve UE context request message to a source access node, the retrieve UE context request message indicating the MAC-I version provided by the UE;
receiving a retrieve UE context response message from the source access node; and
transmitting a message to the UE based on the retrieve UE context response message received from the source access node.

50. The method of claim 49, wherein the MAC-I capability of the target access node indicates a capability of the target access node to support a MAC-I version comprising a source cell identifier, a target cell identifier, a source temporary identifier, and one or more IEs from the RRC resume request message.
